(19) United States
(12) Patent Application Publication
(10) Pub. No.: US 2007/0277774 A1
(43) Pub. Date: Dec. 6, 2007

(54) APPARATUS, SYSTEM, AND METHOD FOR A CENTRIFUGAL TURBINE ENGINE

(76) Inventor: J. Gabriel Allred, American Fork, UT (US)

Correspondence Address: Kunzler & McKenzie, 8 EAST BROADWAY, SUITE 600, SALT LAKE CITY, UT, 84111, US

(21) Appl. No.: 11/668,357

(22) Filed: Jan. 29, 2007

Related U.S. Application Data
(60) Provisional application No. 60/763,000, filed on Jan. 27, 2006.

(51) Int. Cl. F02B 53/00

(52) U.S. Cl. 123/243

(57) ABSTRACT

An apparatus, system, and method are disclosed for a centrifugal turbine engine. The engine includes an engine block with a raceway comprising an inner diameter, a compression ramp, and an exhaust ramp and a rotor disposed within the engine block such that the rotor rotates within the inner diameter of the engine block. The rotor includes a plurality of vanes attached to the rotor such that the vanes retract as each vane sweeps across the compression ramp and the exhaust ramp and extend as each vane passes the compression ramp and the exhaust ramp. The extension is restricted such that the vane does not contact the inner diameter of the engine block during at least a portion of a combustion stroke. Beneficially, the engine is more efficient and reliable than existing engines.

This application claims the benefit of U.S. Provisional Patent Application No. 60/763,000 entitled “Apparatus, system, and method for a centrifugal turbine engine” and filed on Jan. 27, 2006 for J. Gabriel Allred, which is incorporated herein by reference.

### BACKGROUND OF THE INVENTION

1. Field of the Invention

This invention relates to internal combustion engines and more particularly relates to rotary vane engines.

2. Description of the Related Art

There are many types of previously known internal combustion engines. Among them are conventional piston engines in common use today. Another type of engine, the rotary engine, substitutes a rotor for pistons, producing several advantages over the conventional piston engine. These advantages include higher power to weight ratios, mechanical simplicity, and lower vibration.

One type of rotary engine, the rotary vane engine, uses vanes attached to a rotor to form chambers in the engine. The vanes form seals with a housing, and as the rotor rotates, the engine generates power. The rotary vane engine shares the advantages over conventional piston engines with other types of rotary engines.

Despite these advantages, rotary vane engines have not enjoyed widespread commercial success. Reasons for this lack of success include inefficiency, expensive and complicated means to urge the vanes into sealing contact with the wall defining the combustion chamber, and failure of the seals.

### SUMMARY OF THE INVENTION

From the foregoing discussion, it should be apparent that a need exists for an apparatus, system, and method for an efficient rotary vane engine. Beneficially, such an apparatus, system, and method would generate work in a manner more efficient and more reliable than existing designs.

The present invention has been developed in response to the present state of the art, and in particular, in response to the problems and needs in the art that have not yet been fully solved by currently available engines. Accordingly, the present invention has been developed to provide an apparatus, system, and method for a centrifugal turbine engine that overcome many or all of the above-discussed shortcomings in the art.

The apparatus for a rotary vane engine is provided including an engine block with an inner diameter, a compression ramp, and an exhaust ramp, the inner diameter defined by a raceway, the compression ramp and the exhaust ramp forming a progressively smaller raceway. The rotary vane engine may also include a rotor disposed within the engine block such that the rotor rotates within the inner diameter of the engine block. Additionally, the engine may include a plurality of vanes attached to the rotor such that the vanes retract as each vane sweeps across the compression ramp and the exhaust ramp, extend as each vane passes the compression ramp and the exhaust ramp, the extension restricted such that the vane does not contact the inner diameter of the engine block during at least a portion of a combustion stroke, and form chambers in conjunction with the engine block and the rotor that increase in volume during an intake stroke and a combustion stroke, and decrease in volume during a compression stroke and an exhaust stroke.

The apparatus, in one embodiment, also includes a toroidal damper interacting with each of the plurality of vanes. The toroidal damper may comprise a mass disposed on the rotor such that the toroidal damper rotates around a damper axis and has a moment of inertia. Additionally, the toroidal damper may rotate in response to extension of the vane and resist a radial acceleration of the vane during extension in response to the moment of inertia of the toroidal damper.

The apparatus is further configured, in one embodiment, such that the moment of inertia of the toroidal damper is tailored such that the rotor rotates a specific amount of rotation beyond the compression ramp before the vane extends to form an extended vane interface with the raceway. In certain embodiments, the moment of inertia of the toroidal damper is tailored such that the rotor rotates sixty degrees beyond the compression ramp before the vane extends to form an extended vane interface with the raceway.

In a further embodiment, the extension of each of the plurality of vanes in the apparatus is halted by an interaction between a shoulder on the vane and a braking surface on the rotor such that the plurality of vanes are prevented from being in contact with the inner diameter of the engine block. In one embodiment of the apparatus, the interaction between the shoulder on the vane and the braking surface comprises an oil cushion formed by oil disposed on the braking surface such that the extension of the vane is decelerated by the oil cushion.

In one embodiment of the apparatus, the plurality of vanes comprises three vanes. In another embodiment, the extension of each of the plurality of vanes is caused by an inertia of each of the plurality of vanes. In a further embodiment, each of the plurality of vanes further comprises a face with a curved profile, the curved profile corresponding to a curved profile of the raceway of the engine block at an extended vane interface. The apparatus may also include vanes with a friction plate disposed on an edge of each of the plurality of vanes such that the wear plate forms an interface with the engine block. The friction plate may comprise aluminized graphite. In one embodiment of the apparatus, a fuel is ignited by compression.

An apparatus of the present invention is also presented for a centrifugal turbine engine. The apparatus may be embodied by an engine block with an inner diameter, a compression ramp, and an exhaust ramp, the inner diameter defined by a raceway, the compression ramp and the exhaust ramp forming a progressively smaller raceway. The apparatus may also include a rotor disposed within the engine block such that the rotor rotates within the inner diameter of the engine block. Additionally, the apparatus may include a plurality of vanes attached to the rotor such that each of the plurality of vanes retract as each vane sweeps across the compression ramp and the exhaust ramp; extend as each vane passes the compression ramp and the exhaust ramp, the extension restricted such that the vane does not contact the inner diameter of the engine block during at least a portion of a combustion stroke, wherein the extension of each vane is controlled such that the rotor rotates sixty degrees beyond the compression ramp before the vane extends to form an extended vane interface with the raceway; and form chambers in conjunction with the engine block and the rotor that increase in volume during an intake stroke and a combustion stroke, and decrease in volume during a compression stroke and an exhaust stroke.

The extension of each vane in the apparatus may be controlled by a toroidal damper interacting with each of the plurality of vanes. In one embodiment, the toroidal damper comprises a mass disposed on the rotor such that the toroidal damper rotates around a damper axis and has a moment of inertia, rotates in response to extension of the vane, and resists an acceleration of the vane during extension in response to the moment of inertia of the toroidal damper.

In one embodiment of the apparatus, a continuous flow of fuel is introduced into a combustion chamber. In a further embodiment, the extension of each of the plurality of vanes is caused by an inertia of each of the plurality of vanes.

An apparatus of the present invention is also presented for a rotary vane engine. In one embodiment, the apparatus includes an engine block with an inner diameter, a compression ramp, and an exhaust ramp, the inner diameter defined by a raceway, the compression ramp and the exhaust ramp forming a progressively smaller raceway. The apparatus may also include a rotor disposed within the engine block such that the rotor rotates within the inner diameter of the engine block. Additionally, the apparatus may include a plurality of vanes attached to the rotor such that each of the plurality of vanes retract as each vane sweeps across the compression ramp and the exhaust ramp and extend as each vane passes the compression ramp and the exhaust ramp, the extension restricted such that the vane does not contact the inner diameter of the engine block during a combustion stroke.

The extension of each vane, in one embodiment of the apparatus, is controlled by a toroidal damper interacting with each of the plurality of vanes wherein the toroidal damper comprises a mass disposed on the rotor such that the toroidal damper rotates around a damper axis and has a moment of inertia, rotates in response to extension of the vane, and resists a radial acceleration of the vane during extension in response to the moment of inertia of the toroidal damper. In one embodiment, the vanes form chambers in conjunction with the engine block and the rotor that increase in volume during an intake stroke and a combustion stroke, and decrease in volume during a compression stroke and an exhaust stroke.

The moment of inertia of the toroidal damper of the apparatus also may be tailored such that the rotor rotates a specific amount of rotation beyond the compression ramp before the vane extends to form an extended vane interface with the raceway. In another embodiment, the moment of inertia of the toroidal damper is tailored such that the rotor rotates sixty degrees beyond the compression ramp before the vane extends to form an extended vane interface with the raceway. In a further embodiment, the extension of each of the plurality of vanes is caused by an inertia of each of the plurality of vanes.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view illustrating one embodiment of an engine block in accordance with the present invention;

FIG. 2 is a side view illustrating one embodiment of rotor in accordance with the present invention;

FIG. 3A is a front view illustrating one embodiment of a vane in accordance with the present invention;

FIG. 3B is a front view illustrating one embodiment of a vane in accordance with the present invention;

FIG. 4 is a side view illustrating one embodiment of an engine block with an installed rotor in accordance with the present invention;

FIG. 5A is a bottom view illustrating one embodiment of an engine in accordance with the present invention;

FIG. 5B is a bottom cutaway view illustrating one embodiment of an engine in accordance with the present invention;

FIG. 6 is a cross section side view illustrating one embodiment of an assembled engine in four strokes in accordance with the present invention;

FIG. 7 is a cross section side view illustrating one embodiment of an assembled engine in four phases of turbine combustion in accordance with the present invention;

FIG. 8A is a side view illustrating one embodiment of a portion of a rotor with an extended vane in accordance with the present invention; and

FIG. 8B is a side view illustrating one embodiment of a portion of a rotor with a retracted vane in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

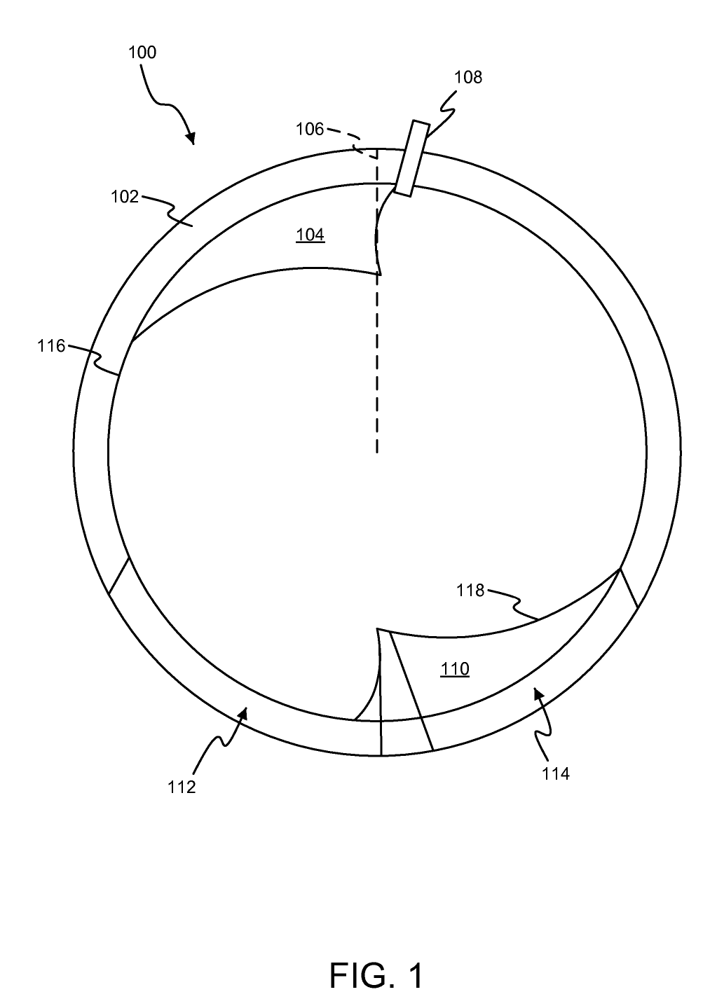

FIG. 1 illustrates one embodiment of a side view of an engine block 100 according to the present invention. The engine block 100 includes a housing 102, a compression ramp 104, a fuel injector 108, an exhaust ramp 110, an air intake port 112, and an exhaust port 114. The engine block 100 contains and directs gasses and fluids in an internal combustion engine.

In one embodiment, the housing 102 is an annular structure that forms the outer surface of the block 100 and provides surfaces to form seals with the rotor (not shown). The housing 102 may be made from any material rigid and impermeable enough to contain the gasses in the engine, such as steel, aluminum, titanium, a composite material, or the like. In one embodiment, the housing 102 may be made from S1 steel.

The housing 102, in one embodiment, may be of any size. The power generated by the engine is related to the overall displacement of the engine, and in one embodiment, the housing 102 may be sized depending on the power needs of the engine. The housing 102 may include an inner diameter 116 at the widest portion of the housing 102. In one embodiment, the housing 102 may have an inner diameter 116 of about ten inches.

The compression ramp 104, in one embodiment, is a curved structure that reduces the volume of a chamber as the rotor (not shown) is swept across the compression ramp 104. The curve and height of the compression ramp 104 can be of any size within the constraints of the housing 102 and may be modified to impact the rate of compression and the compression ratio of the engine. In one embodiment, the compression ramp 104 may have a height of about two inches. In another embodiment, the compression ramp 104 may begin at a point on the housing 102 45 degrees counter clockwise from the top dead center line (TDC) 106, a line extending from the center of the housing 102 to the top of the housing 102.

In one embodiment, the compression ramp 104 may be formed from any material rigid, strong, and impermeable enough to contain the gasses in the engine and interact with the rotor (not shown), such as steel, aluminum, titanium, a composite material, or the like. In one embodiment, the compression ramp 104 may be made from S1 steel. In an alternative embodiment, the compression ramp 104 may be formed integral with the housing 102.

The fuel injector 108, in one embodiment, introduces fuel into the engine block 100 from outside the engine block 100. The fuel injector 108 may meter the flow of the fuel into the engine. In one embodiment, the fuel injector may be an electronic fuel injector.

As will be appreciated by one skilled in the art, a variety of fuel injectors 108 may be employed and should be considered within the scope of the present invention. For example, in an alternate embodiment, the fuel injector 108 may be a high-pressure, mechanical fuel injector. In another embodiment, the fuel injector 108 may be a venturi injector. In yet another embodiment, the fuel injector 108 may be configured to inject multiple types of fuel.

The fuel injector 108, in one embodiment, may be located near a glow plug (not shown). The glow plug increases the temperature of the fuel in the engine when the engine is starting, and allows the fuel to ignite in a compression engine when starting. In an alternative embodiment, the engine may include a spark plug (not shown) near the fuel injector 108 to ignite the fuel in the engine.

In one embodiment, the exhaust ramp 110 is a curved structure that reduces the volume of a chamber as the rotor (not shown) is swept across the exhaust ramp 110. The curve and height of the exhaust ramp 110 can be of any size within the constraints of the housing 102 and may be modified to impact the rate of exhaust expulsion of the engine. In one embodiment, the exhaust ramp 110 may have a height of about two inches. In another embodiment, the exhaust ramp 110 may end at a point about 180 degrees from TDC 106 and may begin at a point on the housing 102 about 45 degrees counter clockwise from the end of the exhaust ramp 110.

In one embodiment, the exhaust ramp 110 may be formed from any material rigid, strong, and impermeable enough to contain the gasses in the engine and interact with the rotor (not shown), such as steel, aluminum, titanium, a composite material, or the like. In one embodiment, the exhaust ramp 110 may be made from S1 steel. In an alternative embodiment, the exhaust ramp 110 may be formed integral with the housing 102.

Surfaces of the inner diameter 116, the compression ramp 104, and the exhaust ramp 110 may make up a raceway 118. The raceway 118 forms a surface which interacts with vanes (not shown) to form chambers for compression, combustion, intake, and exhaust. The vanes (not shown) may sweep along the raceway 118. The compression ramp 104 and the exhaust ramp 110 effectively form a progressively smaller diameter raceway 118

The intake port 112, in one embodiment, is a port through the housing 102 into the engine block 100. The intake port 112 provides a pathway for air to be drawn into the engine as it operates. The intake port 112 may be sized to match the airflow requirements of the engine. The intake port 112, in one embodiment, has a cross-sectional area equal to a vane (not shown) on the rotor (not shown). In one embodiment, the intake port 112 is a channel beginning at about 180 degrees from TDC 106 and extending to about 120 degrees counter clockwise from TDC 106.

As will be appreciated by one skilled in the art, a variety of types and configurations of intake port 112 may be utilized without departing from the scope and spirit of the present invention. For example, in one embodiment, the intake port 112 may be located in a head plate (not shown). In another embodiment, the intake port 112 may have an elliptical cross-sectional shape. In yet another embodiment, the surface of the intake port 112 may be polished to improve airflow. In a further embodiment, the intake port 112 may have a geometry optimized to create a minimum resistance to air flow.

The exhaust port 114, in one embodiment, is a port through the housing 102 into the engine block 100. The exhaust port 114 provides a pathway for combustion gasses to be expelled from the engine as it operates. The exhaust port 114 may be sized to match the exhaust requirements of the engine. The exhaust port 114, in one embodiment, has a cross-sectional area equal to a vane (not shown) on the rotor (not shown). In one embodiment, the exhaust port 114 is a channel beginning at about 120 degrees clockwise from TDC 106 and extending to about 180 degrees from TDC 106.

As will be appreciated by one skilled in the art, a variety of types and configurations of exhaust port 114 may be utilized without departing from the scope and spirit of the present invention. For example, in one embodiment, the exhaust port 114 may be located in a head plate (not shown). In another embodiment, the exhaust port 114 may have an elliptical cross-sectional shape. In yet another embodiment, the surface of the exhaust port 114 may be polished to improve airflow. In a further embodiment, the intake exhaust port 114 may have a geometry optimized to create a minimum resistance to air flow.

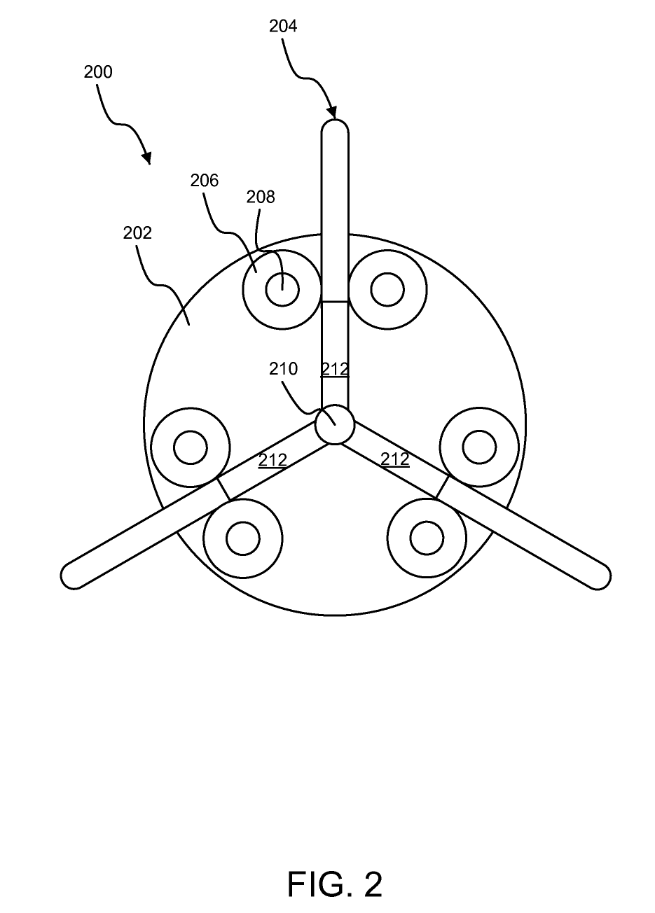

FIG. 2 illustrates one embodiment of a cross-section side view of a rotor 200 according to the present invention. The rotor 200 includes a crank 202, vanes 204, and vane extension dampers 206. The rotor 200 rotates within the engine block 100 in response to compressed gasses.

In one embodiment, the crank 202 is sized to fit within the compression ramp 104 and the exhaust ramp 110. The crank 202 provides a mounting platform for the other components of the rotor 200 and provides a surface which, combined with the vanes 204, and surfaces in the block 100, form chambers in the engine. The crank 202 rotates around a crank axis 210. In one embodiment, the crank 202 is connected to a dive shaft (not shown) at the crank axis 210. In another embodiment, the crank 202 is connected to a starter motor (not shown) at the crank axis 210.

In one embodiment, the crank 202 may be formed from any material rigid, strong, and impermeable enough to contain the gasses in the engine and support the other components of the rotor 200, such as steel, aluminum, titanium, a composite material, or the like. In one embodiment, the crank 202 may be made from S1 steel.

The vanes 204, in one embodiment, provide surfaces which, in conjunction with other surfaces in the engine, form chambers in the engine. The vanes 204 are connected to the crank 202, and rotate with the crank around the crank axis 210. The vanes 204 have a variable amount of projection beyond the crank 202 which allows the vanes 204 to follow the contours of the raceway 118 as the crank 202 rotates. In one embodiment, the vanes 204 are arranged around the crank axis 210 at 120 degree increments.

In one embodiment, the vanes 204 are disposed in tracks 212 in the crank 202. Each vane 204 may slide within the track 212 such that the vane 204 may radially extend or retract relative to the rotor 200. As the vane 204 retracts, it slides along the track 212 into the rotor 202.

In one embodiment, the vanes 204 extend in response to the inertia of the vanes 204. As the rotor 200 rotates, the mass of the vanes 204 causes the vanes 204 to extend radially away from the center of the rotor 200. This tendency for a mass to move away from a rotating body is often described as an effective force known as centrifugal force. When a vane 204 is free to slide in a track 212 while the rotor 200 is rotating, the vane will experience an effective force that causes it to extend.

In one embodiment, the vanes 204 may be formed from any material rigid, strong, and impermeable enough to contain the gasses in the engine and withstand the forces generated as the engine operates, such as steel, aluminum, titanium, a composite material, or the like. In one embodiment, the vanes 204 may be made from 7% manganese titanium.

In one embodiment, the rotor 200 may include one or more vane extension dampers 206. As the crank 202 rotates, the vanes 204 are drawn across the compression ramp 104 and the exhaust ramp 110. As the vanes 204 transit the ramps 104, 110, they are compressed. When the vanes 204 pass the ramps 104, 110, they are free to extend to their full length. The vane extension dampers 206 control the rate extension of the vanes 204 by resisting the radial acceleration of the vanes 204.

In one embodiment, the vane extension dampers 206 are toroidal bodies that rotate around a damper axis 208. The dampers 206 interact with the vane 204 such that the damper 206 rotates as the vane 204 slides relative to the track 212. In one embodiment, the damper 206 has gear teeth that mesh with similar gear teeth on the vane 204. In another embodiment, the damper 206 is in contact with the vane 204 and is driven by friction as the vane 204 moves relative to the track 212.

The damper 206, in one embodiment, has a rotational inertia relative to its physical characteristics, such as its shape and distribution of mass within that shape known as a moment of inertia. The moment of inertia of the damper 206 can be tailored to control the rate of extension of the vane 204 as the rotor 200 rotates within the block 100.

In one embodiment, as a compressed vane 204 rotates, the inertia of the vane 204 will cause it to extend. As the angular velocity of the rotor 200 increases, the tendency of the vane 204 to extend will also increase. In one embodiment, the damper 206 exerts a force on the vane 204 resisting radial acceleration of the vane 204 that increases as the rate of radial acceleration of the vane 204 increases. In another embodiment, the moment of inertia of the damper 206 can be tailored such that the vane 204 reaches full extension at a specified amount of rotation past TDC 106 at any operational rotational speed of the rotor 200. In one embodiment, the damper 206 is tailored to cause the vane 204 to reach full extension at 60 degrees past TDC 106 and 240 degrees past TDC 106.

As will be appreciated by one skilled in the art, a variety of configurations and types of vane extension damper 206 may be employed without departing from the scope and spirit of the present invention. For example, a hydraulic damper 206 may be employed that links the extension of one or more vanes 204 to the retraction of one or more vanes 204 such that the net extension or retraction among all the vanes 204 is zero. In another embodiment, the vane extension dampers 206 may comprise air springs linked to the vanes 204 that control the rate of extension. In another embodiment, the dampers 206 may comprise springs that are linked to the vanes that exert force on the vanes 204 that resist extension.

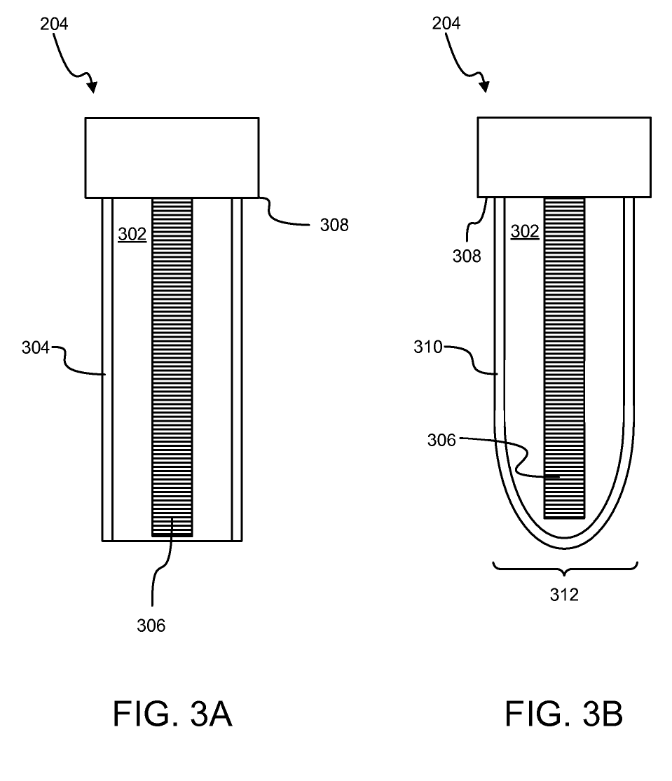

FIG. 3A illustrates one embodiment of a front view of a vane 204 according to the present invention. The vane 204 is preferably configured in a manner similar to a like number component in relation to FIG. 2. The vane 204 includes a face 302, one or more friction plates 304, a vane extension damper interface 306, and a shoulder 308. The vane 204 moves as described in FIG. 2 relative to the crank 202 as the rotor 200 rotates.

In one embodiment, the face 302 acts as a wall of a chamber in the engine and provides a foundation for the friction plates 304 and the vane extension damper interface 306. The face 302 may be formed from any material rigid, strong, and impermeable enough to contain the gasses in the engine and withstand the forces generated as the engine operates, such as steel, aluminum, titanium, a composite material, or the like. In one embodiment, the face 302 may be made from 7% manganese titanium.

The friction plate 304, in one embodiment, forms the interface between the vane 204 and the engine block 100. As the rotor 200 rotates, the vanes 204 may interact with the engine block '00 and produce friction. This friction produces heat and causes wear.

The friction plate 304, in one embodiment, is made of a material that reduces wear on the engine block 100. In another embodiment, the friction plate 304 is made of a material that resists wear on the friction plate 304. In a further embodiment the friction plate 304 is made of a material that reduces the friction between the friction plate 304 and the engine block 100.

The friction plate 304, in one embodiment, may be formed from any material that has the physical characteristics required to produce the desired effect on the friction between the vane 204 and the head plate, such as steel, aluminum, titanium, a composite material, or the like. In one embodiment, the friction plate 304 may be made from M1 steel. In another embodiment, the friction plate 310 may be made from M2 steel. In an alternate embodiment, the friction plate 304 may be made from aluminized graphite.

The vane extension damper interface 306, in one embodiment, interacts with the vane extension damper 206 to exert a force that resists extension of the vane 204. In one embodiment, the vane extension damper interface 306 comprises a row of gear teeth that mate with gear teeth on the damper 206. In another embodiment, the vane extension damper interface 306 comprises more than one row of gear teeth that mate with gear teeth on the damper 206. In yet another embodiment, the vane extension damper interface 306 comprises a surface that interacts with the damper 206 through friction.

The shoulder 308, in one embodiment, interacts with a braking surface (not shown) on the rotor 200 to halt the extension of the vane 204. The shoulder 308 may comprise an area of the vane 204 that extends beyond the area of the face 302. In one embodiment, the shoulder 308 may be cast with the vane 204 or machined from a single piece of material with the vane 204. In an alternate embodiment, the shoulder 308 may be

FIG. 3B illustrates another embodiment of a front view of a vane 204 according to the present invention. The vane 204 includes a face 302, a friction plate 310, a vane extension damper interface 306, a shoulder 308, and a curved profile 312. The vane 204, extension damper interface 306, and shoulder 308 are preferably configured in a manner similar to like number components in relation to FIG. 3A. The vane 204 moves as described in FIG. 2 relative to the crank 202 as the rotor 200 rotates.

The face 302, in one embodiment, acts as a wall of a chamber in the engine and provides a foundation for the friction plate 310 and the vane extension damper interface 306. The face 302 may be formed from any material rigid, strong, and impermeable enough to contain the gasses in the engine and withstand the forces generated as the engine operates, such as steel, aluminum, titanium, a composite material, or the like. In one embodiment, the face 302 may be made from 7% manganese titanium. The face 302 may include a curved profile 312. The curved profile 312 may correspond to a curved profile (not shown) of the raceway 118 to form an extended vane interface.

In one embodiment, the friction plate 310 is disposed around the edge of the face 302 of the vane 204. The friction plate 310 forms the closest point to the raceway 118 during operation of the engine and acts to reduce friction and wear between the vane 204 and the engine block 100. The friction plate 310 may form an interface with the engine block 100.

The friction plate 310, in one embodiment, may be formed from any material that has the physical characteristics required to produce the desired effect on the friction between the vane 204 and the head plate, such as steel, aluminum, titanium, a composite material, or the like. In one embodiment, the friction plate 310 may be made from M1 steel. In another embodiment, the friction plate 310 may be made from M2 steel. In an alternate embodiment, the friction plate 310 may be made from aluminized graphite.

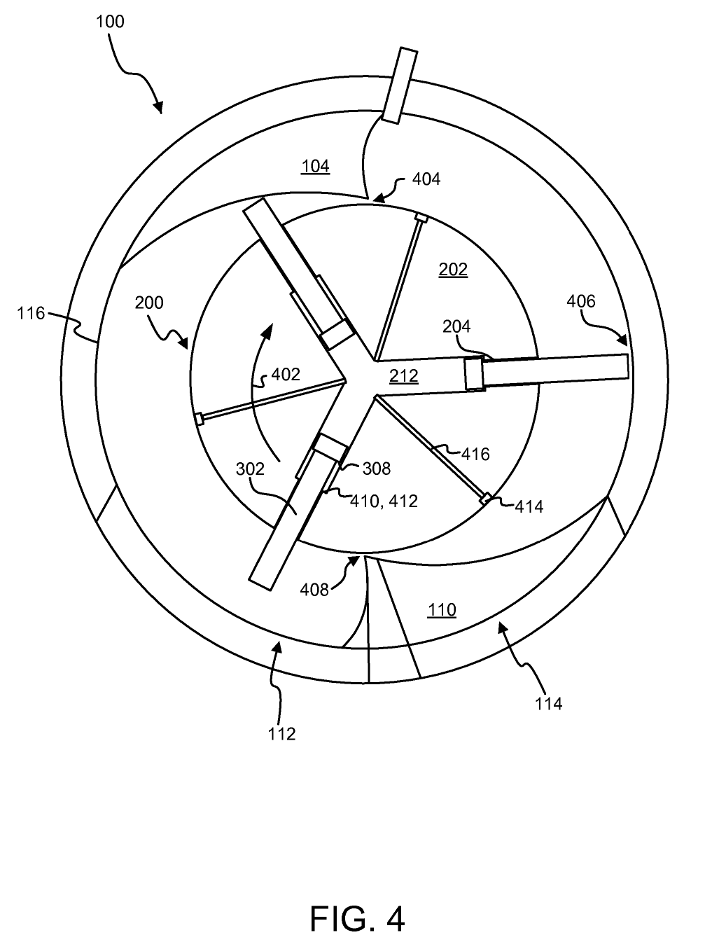

FIG. 4 illustrates one embodiment of an engine block 100 with an installed rotor 200. The engine block 100 is preferably configured in a manner similar to a like numbered component in relation to FIG. 1, and the rotor 200 is preferably configured in a manner similar to a like numbered component in relation to FIG. 2. The rotor 200 rotates in a clockwise direction within the block 100 as indicated by the arrow 402. The installed rotor 200 may include a compression ramp interface 404, an extended vane interface 406, an exhaust ramp interface 408, and a gas check port 414.

In one embodiment, the compression ramp interface 404 allows compressed air to pass from a compression chamber to a combustion chamber while resisting the flow of gas from the combustion chamber into the compression chamber. In one embodiment, the compression ramp interface 404 is a gap between the crank 202 and the compression ramp 104 sized allow compressed air to pass into the combustion chamber while resisting the flow of combustion gasses in the opposite direction through the effect of turbulence. In one embodiment, the compression ramp interface 404 is a 0.3 inch gap between the crank 202 and the compression ramp 104.

The extended vane interface 406, in one embodiment, forms a seal between an extended vane 204 and the inner diameters 16 of the engine block 100. The seal between the extended vanes 204 and the inner diameter 116 allows the expanding gas in the compression chamber to rotate the rotor 200 and also causes the rotating rotor 200 to expel exhaust, draw in air through the intake, and compress air.

In one embodiment, the extended vane 204 does not contact the inner diameter 116, but forms a seal by leaving a small gap between the vane 204 and the housing 102. The gap at the extended vane interface 406 is sized such that gas flowing through the gap generates turbulence that resists rapid flow of the gas. In another embodiment, the vane contacts the inner diameter 116 at the extended vane interface 406 to form a seal.

The exhaust ramp interface 408, in one embodiment, resists the flow of gas past the interface 408, causing exhaust gas to be expelled through the exhaust port 114 and air to be drawn in through the intake 112. In one embodiment, the exhaust ramp interface 408 is a gap between the crank 202 and the exhaust ramp 110 sized such that gas flowing through the gap generates turbulence that resists rapid flow of the gas. The gap at the exhaust ramp interface 408 is one eighth of an inch in one embodiment.

The rotor 200 may include a plurality of vanes 204 and tracks 212. The vanes 204 may slide within the tracks 212 to allow each of the vanes 204 to radially extend and retract relative to the rotor 200. In one embodiment, the extension of a vane 204 may be halted by an interaction between the shoulder 308 of the vane 204 and a braking surface 410 on the rotor 200. The braking surface 410 may comprise a portion of the track 212 that is narrower than the shoulder 308, but wide enough to allow the body 302 of the vane 204 to slide through the track 212. As a result, the vane 204 will extend freely until the shoulder 308 interacts with the braking surface 310.

In one embodiment, the braking surface 310 is positioned on the rotor 200 such that the extension of the vane 204 is halted such the vane 204 does not come in contact with the inner diameter 116 of the engine block 100. The vane 204 may leave a gap at the extended vane interface 406 when the shoulder 308 interacts with the braking surface 410.

The braking surface 410, in one embodiment, may include an oil cushion 412 at the braking surface 410. The oil cushion 412 is formed by oil disposed on the braking surface 410. As the shoulder 308 approaches the braking surface 410, the shoulder 308 interacts with the oil cushion 412, decelerating the extension of the vane 204. In one embodiment, the oil cushion 412 may be disposed in a reservoir located on the braking surface 410. The oil in the oil cushion 412 may be supplied by an oil galley in the crank 202.

The gas check port 414, in one embodiment, allows gasses to flow into the track 212 to generate a pressure in the track 212. The gas check port 414 may comprise a check valve that allows high-pressure combustion gas in the combustion chamber to enter the track 212. The gas check port 414 may be disposed on the outer surface of the crank 202 such that as the rotor 200 rotates, the check port passes through areas with relative high pressure gasses and relatively low pressure gasses. In one embodiment, the rotor 200 includes a gas check port 414 between every pair of vanes 204. In another embodiment, the gas check port 414 may enter the combustion chamber when a vane 204 has swept sixty degrees beyond the compression ramp 104.

The high pressure gas may be delivered from the gas check port 414 to the track through a channel 416. The channel may be cast into the crank 202. In an alternate embodiment, the channel 416 may be machined into the crank 202.

The pressure created in the track 212 by the gas check port 414 results in a force causing the vanes 204 to extend when the pressure in the track 212 exceeds the pressure surrounding the vane 204. As a result, when the vane 204 is in a relatively low pressure area of the engine 100, the pressure assists in extending the vane 204. When the vane 204 is in a relatively high pressure area, such as the combustion chamber, the net pressure on the vane 204 may be neutral or it may result in a force resisting extension. Even when the net pressure resists extension, by allowing pressure into the track 212, the gas check valve 414 reduces the overall pressure differential, and limits the amount of force resisting extension due to pressure.

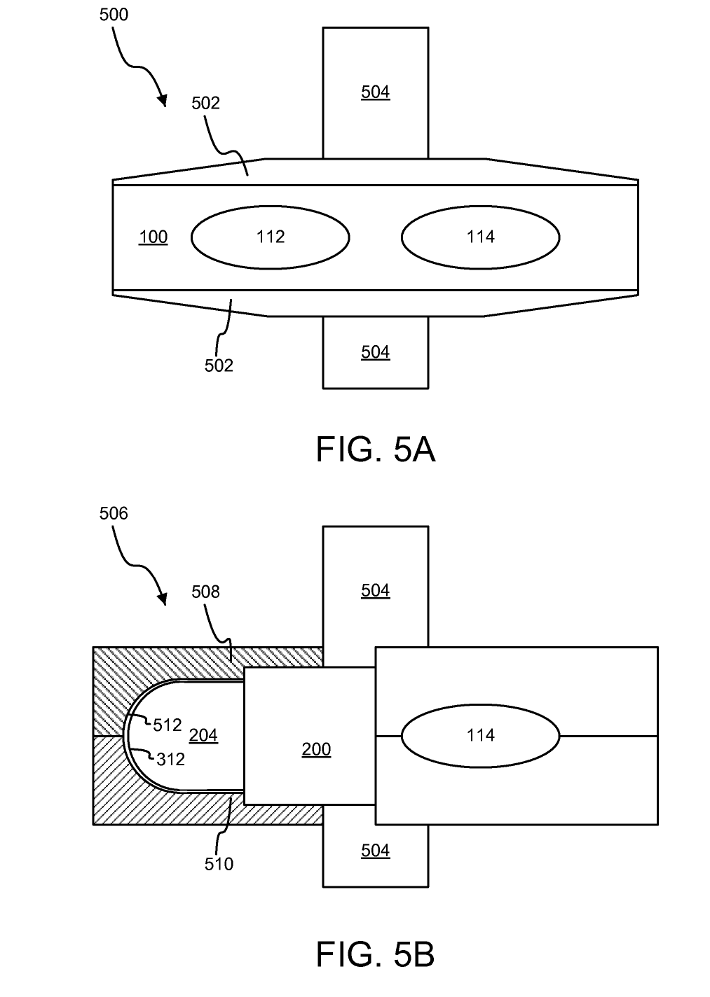

FIG. 5A is a bottom view illustrating one embodiment of an engine 500. The engine 500 includes a block 100 with an intake port 112 and an exhaust port 114, a head plate 502, and a drive shaft 504. The block 100, intake port 112 and exhaust port 114 are preferably configured in a manner similar to like numbered components described in relation to FIG. 1.

In one embodiment, the head plate 502 attaches to the block 100 and interacts with the block 100 and the rotor 200 to form chambers. The head plate 502, in one embodiment, comprises a disc with a central hole for the drive shaft 504. The head plate may be attached to the block 100 by fasteners, such as bolts or the like, by a weld, by clips, or by other like devices.

The head plate 502 may be formed from any material rigid, strong, and impermeable enough to contain the gasses in the engine and withstand the forces generated as the engine operates, such as steel, aluminum, titanium, a composite material, or the like. In one embodiment, the head plate 502 may be made from S1 steel.

In one embodiment, the engine 500 includes two head plates 502 mounted on opposite sides of the block 100. In one embodiment, both head plates 502 include a hole for a drive shaft 504. In an alternate embodiment, one head plate 504 does not include a hole for a drive shaft. The head plate 502, in one embodiment, includes raised vanes on the outer surface to dissipate heat.

The drive shaft 504, in one embodiment, connects to the rotor 200 as described in relation to FIG. 2. The drive shaft 504 transfers the power generated as the rotor 200 rotates to components outside of the engine 500. In one embodiment, a drive shaft 504 extends from only one side of the engine 500. In another embodiment, a drive shaft 504 extends through both head plates 502 to both sides of the engine 500.

In one embodiment, the drive shaft 504 is connected to a starter motor (not shown) as described in relation to FIG. 2. In another embodiment, a drive shaft 504 is connected to a drive shaft of another engine (not shown) for operation in series to generate more power.

The drive shaft 504 may be formed from any material rigid and strong enough to withstand the forces generated as the engine operates, such as steel, aluminum, titanium, a composite material, or the like. In one embodiment, the drive shaft 504 may be made from S1 steel.

FIG. 5B is a bottom cutaway view illustrating one embodiment of an engine 506. The engine 506 includes a two-piece block 508, 510, an exhaust port 114, a vane 204 with a curved profile 312, a rotor 200, and a drive shaft 504. An intake port (not shown) is located in the portion of the two-piece block 508, 510 removed by the cutaway. The exhaust port 114 and the drive shaft 504 are preferably configured in a manner similar to like numbered components in relation to FIG. 5A. The rotor 200 is preferably configured in a manner similar to a like numbered component in relation to FIG. 4. The vane 204 with a curved profile 312 is preferably configured in a manner similar to a like numbered component in relation to FIG. 3.

The two-piece block 508, 510 contains and directs fluids and gasses in the engine 506. In one embodiment, the two piece block 508, 510 may have a curved profile 512 corresponding to the curved profile 312 of the vane 204. The curved profile 512 and the two-piece block 508, 510 simplify manufacture of the engine 506 and eliminate stress concentration points caused by angles.

In one embodiment, the two-piece block 508, 510 interacts with the vanes 204 and the rotor 200 to form chambers. The two-piece block 508, 510, in one embodiment, includes a central hole for the drive shaft 504. The two-piece block 508, 510 may be secured together by fasteners, such as bolts or the like, by a weld, by clips, or by other like devices.

The two-piece block 508, 510 may be formed from any material rigid, strong, and impermeable enough to contain the gasses in the engine and withstand the forces generated as the engine operates, such as steel, aluminum, titanium, a composite material, or the like. In one embodiment, the two-piece block 508, 510 may be made from S1 steel.

In one embodiment, the two-piece block 508, 510 includes a hole for a drive shaft 504 on opposite sides of the two-piece block 508, 510. In an alternate embodiment, the two-piece block 508, 510 includes only one hole for a drive shaft. The two-piece block 508, 510, in one embodiment, includes raised vanes on the outer surface to dissipate heat.

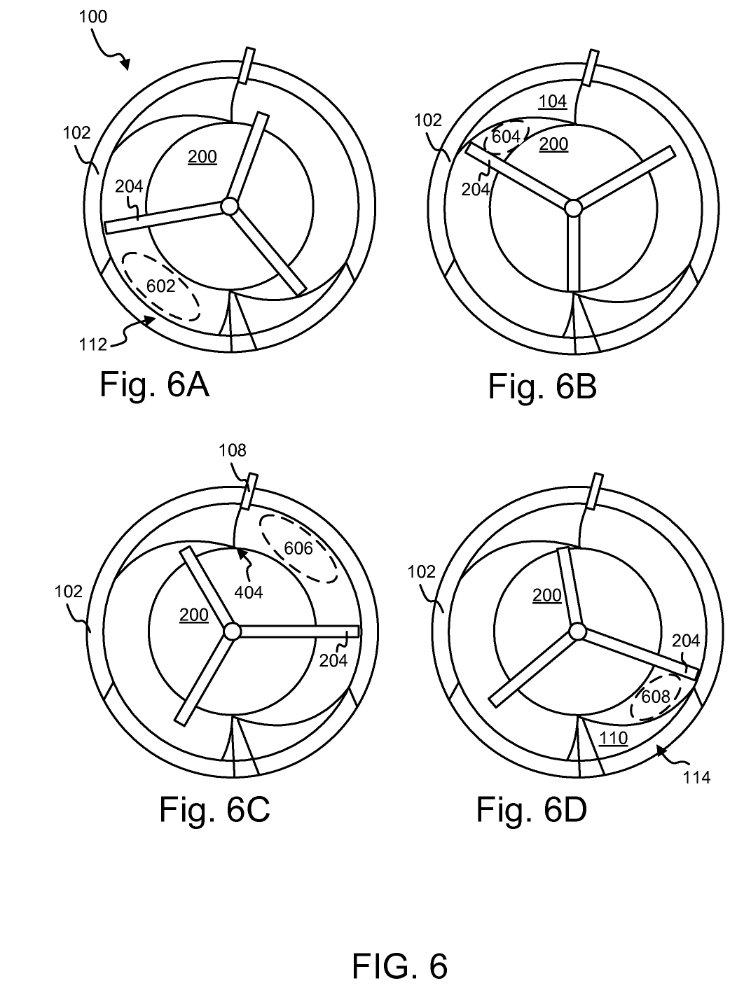

FIG. 6 is a cross section side view illustrating one embodiment of an assembled engine in four strokes, including an intake stroke (FIG. 6A), a compression stroke (FIG. 6B), a combustion stroke (FIG. 6C), and an exhaust stroke (FIG. 6D). The engine progresses through the four strokes illustrated, then repeats the cycle. The illustrations in FIG. 6 include an engine block 100 and a rotor 200, which are preferably configured similarly to like numbered components described in relation to FIG. 4.

FIG. 6A illustrates one embodiment of an intake stroke. As the rotor 200 rotates, a vane 204 sweeps along the raceway 118, increasing the volume of an intake chamber 602. As the volume of the intake chamber 602 increases, the pressure in the chamber 602 decreases. The decreased pressure in the chamber 602 causes air to be drawn through the intake port 112 and into the intake chamber 602.

FIG. 6B illustrates one embodiment of a compression stroke. As the rotor 200 rotates, a vane 204 sweeps along the raceway 118 and up the compression ramp 104, decreasing the volume of a compression chamber 604. As the volume of the compression chamber 604 decreases, the pressure in the chamber 604 increases. The ratio of the volume of the chamber 604 at the beginning of compression to the end of compression (the compression ratio) can be tailored to meet the performance needs of the engine, as described in relation to FIG. 1. In certain embodiments, at high engine speeds the temperature in the compression chamber 604 increases dramatically as the volume of the compression chamber 604 decreases. The increased temperature results in an increased pressure in the compression chamber 604, leading to a higher compression ratio. In one embodiment, the compression ratio is 50:1.

FIG. 6C illustrates one embodiment of a combustion stroke. As the rotor 200 rotates, compressed air passes through the compression ramp interface 404 into a combustion chamber 606. The fuel injector 108 mixes fuel with the compressed air in the combustion chamber 606. In one embodiment, the fuel in the combustion chamber 606 ignites in response to the pressure in the combustion chamber 606. In an alternate embodiment, the fuel in the combustion chamber 606 is ignited by a spark plug (not shown).

When the fuel air mixture ignites in the combustion chamber 606, the pressure of the gas in the combustion chamber 606 increases. The increased pressure generates a force on the vane 204, causing the rotor 200 to rotate.

In one embodiment, the vane 204 does not contact the housing 102 during the combustion stroke. The extension of the vane 204 may be restricted such that a small gap remains between the vane 204 and the housing 102. In one embodiment, a seal between the vane 204 and the housing 102 is created through turbulent flow effects as the combustion gas attempts to flow through the gap into an exhaust chamber 608.

FIG. 6D illustrates one embodiment of an exhaust stroke. As the rotor 200 rotates, a vane 204 sweeps along the raceway 118 and up the exhaust ramp 110, decreasing the volume of the exhaust chamber 608. As the volume of the exhaust chamber 608 decreases, exhaust gasses in the exhaust chamber 608 are forced through the exhaust port 114.

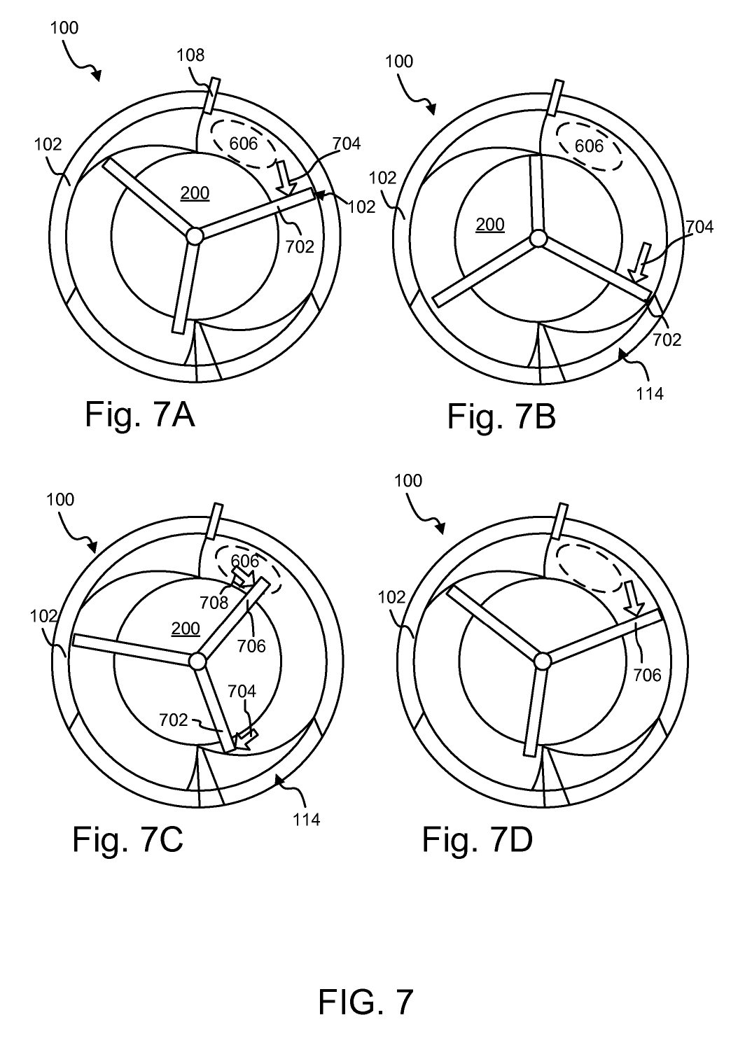

FIG. 7 is a cross section side view illustrating one embodiment of an assembled engine at four sequential moments of turbine combustion in accordance with the present invention, including the beginning of a main expansion phase (FIG. 7A), the end of the main expansion phase (FIG. 7B), the beginning of a transition phase (FIG. 7C), and the end of the transition phase (FIG. 7D). The illustrations in FIG. 7 include an engine block 100 and a rotor 200, which are preferably configured similarly to like numbered components described in relation to FIG. 6. In turbine combustion, the fuel injector 108 injects a continuous stream of fuel into a combustion chamber 606, and ignition of the fuel air mix in the combustion chamber 606 is continuous.

FIG. 7A illustrates one embodiment of the start of the main expansion phase, which begins when a first vane 702 reaches full extension and forms an interface with the raceway 118 at the extended vane interface 406. In one embodiment, the first vane 702 reaches full extension at 60 degrees past TDC 106. Combustion in the combustion chamber 606 occurs continuously as the engine operates, and gasses generated by combustion increase the pressure in the combustion chamber 606. The increased pressure exerts a force 704 on the first vane 702 which causes the rotor 200 to rotate.

FIG. 7B illustrates one embodiment of the end of the main expansion phase, which occurs when the first vane 702 reaches the exhaust port 114. Combustion in the combustion chamber 606 occurs continuously as the engine operates, and gasses generated by combustion increase the pressure in the combustion chamber 606. The increased pressure exerts a force 704 on the first vane 702 which causes the rotor 200 to rotate.

FIG. 7C illustrates one embodiment of the transition phase, which begins as the first vane 702 passes the exhaust port 114. Combustion in the combustion chamber 606 occurs continuously as the engine operates, and gasses generated by combustion increase the pressure in the combustion chamber 606. During the transition phase, there may be an open pathway to the exhaust port 114 from the combustion chamber 606, since a following vane 706 may not have extended completely to form an interface with the housing 102 at the extended vane interface 406.

During the transition period, the expanding gasses in the combustion chamber 606 flow toward the exhaust port 114. As the gasses flow toward the exhaust port 114, they create turbulence that generates a force 708 on the partially extended following vane 706 and continue to apply a force 704 on the first vane 702.

FIG. 7D illustrates one embodiment of the end of the transition phase, which occurs when the following vane 706 reaches full extension and forms an interface with the raceway 118 at the extended vane interface 406. In one embodiment, the following vane 706 reaches full extension at 60 degrees past TDC 106. At the end of the transition phase, the main expansion phase begins as illustrated by FIG. 7A, and the cycle repeats.

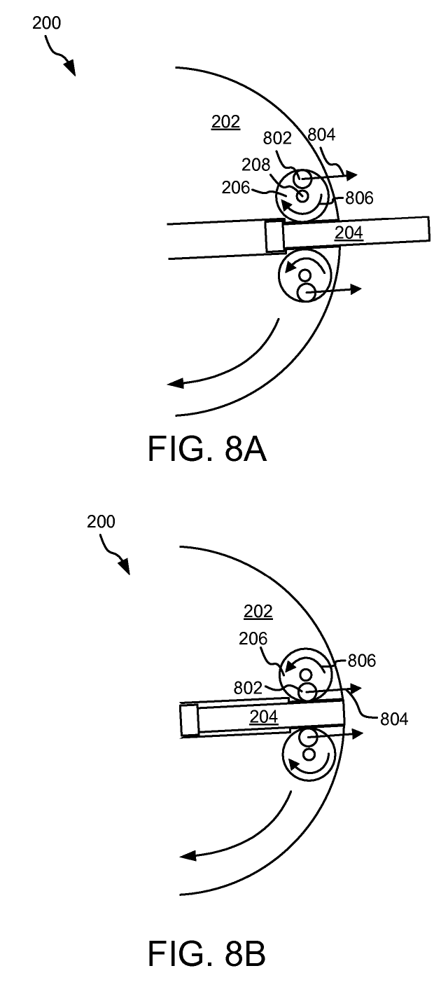

FIG. 8 is a side view of one embodiment of a portion of a rotor 200 illustrating a damper 206 with an eccentric mass 802. The damper 206 with an eccentric mass 802 interacts with the vane 204 as the rotor 200 rotates to decelerate the extension and retraction of the vane 204 as the vane approaches the limits of its travel.

FIG. 8A illustrates the vane 204 at full extension. In one embodiment, as the vane 204 approaches full extension, the damper 206 rotates, moving the eccentric mass 802 to a position on the opposite side of the damper axis 208 from the vane 204. The rotation of the rotor 200 generates an effective force known as centrifugal force on masses rotating with the rotor 200. The centrifugal force 804 acting on the eccentric mass 802 generates a moment 806 on the damper 206 that varies as the damper 206 rotates in response to the extension and retraction of the vane 204. The moment 806 increases as the distance between the eccentric mass 802 and a line drawn from the center of the rotor 200 through the damper axis 208 increases.

When the vane 204 approaches full extension, the eccentric mass 802 generates a moment 806 that resists the extension of the vane 204. In one embodiment, the moment 806 increases as the vane 204 approaches full extension. As illustrated in FIG. 8A, in one embodiment the eccentric mass 802 rotates to a point that generates a maximum moment 806 at full extension of the vane 204.

FIG. 8B illustrates the vane 204 at full retraction. In one embodiment, as the vane 204 approaches full retraction, the damper 206 rotates, moving the eccentric mass 802 to a position on the side of the damper axis 208 nearest the vane 204. The centrifugal force 804 acting on the eccentric mass 802 generates a moment 806 on the damper 206 that varies as the damper 206 rotates in response to the extension and retraction of the vane 204. The moment 806 increases as the distance between the eccentric mass 802 and a line drawn from the center of the rotor 200 through the damper axis 208 increases.

When the vane 204 approaches full retraction, the eccentric mass 802 generates a moment 806 that resists the retraction of the vane 204. In one embodiment, the moment 806 increases as the vane 204 approaches full retraction. As illustrated in FIG. 8B, in one embodiment the eccentric mass 802 rotates to a point that generates a maximum moment 806 at full retraction of the vane 204.

In one embodiment, the damper 206 has a circumference equal to twice the distance that the vane 204 travels between full retraction and full extension. As a result, the damper 206 rotates 180 degrees as the vane 204 travels between full extension and full retraction. In another embodiment, each vane 204 has two dampers 206 on opposite sides of the vane 204. In an alternate embodiment, the damper 206 includes a stop that halts the rotation of the damper 206 as the vane 204 reaches full retraction.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for a rotary vane engine, the apparatus comprising:
an engine block with an inner diameter, a compression ramp, and an exhaust ramp, the inner diameter defined by a raceway, the compression ramp and the exhaust ramp forming a progressively smaller raceway;
a rotor disposed within the engine block such that the rotor rotates within the inner diameter of the engine block; and
a plurality of vanes attached to the rotor such that the vanes:
retract as each vane sweeps across the compression ramp and the exhaust ramp;
extend as each vane passes the compression ramp and the exhaust ramp, the extension restricted such that the vane does not contact the inner diameter of the engine block during at least a portion of a combustion stroke; and
form chambers in conjunction with the engine block and the rotor that increase in volume during an intake stroke and a combustion stroke, and decrease in volume during a compression stroke and an exhaust stroke.

2. The apparatus of claim 1, further comprising a toroidal damper interacting with each of the plurality of vanes wherein the toroidal damper:
comprises a mass disposed on the rotor such that the toroidal damper rotates around a damper axis and has a moment of inertia;
rotates in response to extension of the vane; and
resists a radial acceleration of the vane during extension in response to the moment of inertia of the toroidal damper.

3. The apparatus of claim 2 wherein the toroidal damper further comprises an eccentric mass disposed on the toroidal damper such that:
a moment is generated on the toroidal damper in response to the rotation of the rotor that resists the extension of the vane as the vane approaches a full extension; and
a moment is generated on the toroidal damper in response to the rotation of the rotor that resists the retraction of the vane as the vane approaches a full retraction.

4. The apparatus of claim 3 wherein the toroidal damper is tailored such that the rotor rotates a specific amount of rotation beyond the compression ramp before the vane extends to form an extended vane interface with the raceway.

5. The apparatus of claim 4 wherein the toroidal damper is tailored such that the rotor rotates sixty degrees beyond the compression ramp before the vane extends to form an extended vane interface with the raceway.

6. The apparatus of claim 1, wherein the extension of each of the plurality of vanes is halted by an interaction between a shoulder on the vane and a braking surface on the rotor such that the plurality of vanes are prevented from being in contact with the inner diameter of the engine block.

7. The apparatus of claim 6 wherein the interaction between the shoulder on the vane and the braking surface comprises an oil cushion formed by oil disposed on the braking surface such that the extension of the vane is decelerated by the oil cushion.

8. The apparatus of claim 1 wherein combustion gas enters the rotor such that a pressure is created within the rotor, the pressure acting on the plurality of vanes to create a force, the force in the direction of extension of the plurality of vanes.

9. The apparatus of claim 1, wherein the plurality of vanes comprises three vanes.

10. The apparatus of claim 1, wherein the extension of each of the plurality of vanes is caused by an inertia of each of the plurality of vanes.

11. The apparatus of claim 1, wherein each of the plurality of vanes further comprises a face with a curved profile, the curved profile corresponding to a curved profile of the raceway of the engine block at an extended vane interface.

12. The apparatus of claim 11, wherein each of the plurality of vanes further comprises a friction plate disposed on an edge of each of the plurality of vanes such that the wear plate forms an interface with the engine block.

13. The apparatus of claim 12 wherein the friction plate comprises aluminized graphite.

14. The apparatus of claim 1, wherein a fuel is ignited by compression.

15. The apparatus of claim 1, wherein a fuel is ignited by a spark plug.

16. An apparatus for a centrifugal turbine engine, the apparatus comprising:
an engine block with an inner diameter, a compression ramp, and an exhaust ramp, the inner diameter defined by a raceway, the compression ramp and the exhaust ramp forming a progressively smaller raceway;
a rotor disposed within the engine block such that the rotor rotates within the inner diameter of the engine block;
a plurality of vanes attached to the rotor such that each of the plurality of vanes:
retract as each vane sweeps across the compression ramp and the exhaust ramp;
extend as each vane passes the compression ramp and the exhaust ramp, the extension restricted such that the vane does not contact the inner diameter of the engine block during at least a portion of a combustion stroke; and
form chambers in conjunction with the engine block and the rotor that increase in volume during an intake stroke and a combustion stroke, and decrease in volume during a compression stroke and an exhaust stroke; and
a damper disposed on the rotor, the damper including an eccentric mass, the eccentric mass disposed on the damper such that:
the eccentric mass rotates around a damper axis;
the damper interacts with each of the plurality of vanes;
a moment is generated on the damper in response to the rotation of the rotor that resists the extension of the vane as the vane approaches a full extension; and
a moment is generated on the damper in response to the rotation of the rotor that resists the retraction of the vane as the vane approaches a full retraction.

17. The apparatus of claim 16, wherein the damper has a circumference of twice an extension length of each of the plurality of vanes.

18. The apparatus of claim 16, wherein a continuous flow of fuel is introduced into a combustion chamber.

19. The apparatus of claim 16, wherein the extension of each of the plurality of vanes is caused by an inertia of each of the plurality of vanes.

20. An apparatus for a rotary vane engine, the apparatus comprising:
an engine block with an inner diameter, a compression ramp, and an exhaust ramp, the inner diameter defined by a raceway, the compression ramp and the exhaust ramp forming a progressively smaller raceway;
a rotor disposed within the engine block such that the rotor rotates within the inner diameter of the engine block; and
a plurality of vanes attached to the rotor such that each of the plurality of vanes:
retract as each vane sweeps across the compression ramp and the exhaust ramp;
extend as each vane passes the compression ramp and the exhaust ramp, the extension restricted such that the vane does not contact the inner diameter of the engine block during a combustion stroke;
wherein the extension of each vane is controlled by a toroidal damper interacting with each of the plurality of vanes wherein the toroidal damper comprises a mass disposed on the rotor such that the toroidal damper rotates around a damper axis and has a moment of inertia, rotates in response to extension of the vane, and resists a radial acceleration of the vane during extension in response to the moment of inertia of the toroidal damper; and
form chambers in conjunction with the engine block and the rotor that increase in volume during an intake stroke and a combustion stroke, and decrease in volume during a compression stroke and an exhaust stroke.

21. The apparatus of claim 20, wherein the moment of inertia of the toroidal damper is tailored such that the rotor rotates a specific amount of rotation beyond the compression ramp before the vane extends to form an extended vane interface with the raceway.

22. The apparatus of claim 20 wherein the moment of inertia of the toroidal damper is tailored such that the rotor rotates sixty degrees beyond the compression ramp before the vane extends to form an extended vane interface with the raceway.

23. The apparatus of claim 22, wherein the extension of each of the plurality of vanes is caused by an inertia of each of the plurality of vanes.

24. The apparatus of claim 20 wherein a compression ratio of the rotary vane engine is fifty to one.
